(19) United States
(12) Patent Application Publication
(10) Pub. No.: US 2019/0169551 A1
(43) Pub. Date: Jun. 6, 2019

(54) PROCESSES OF MAKING LIQUID DETERGENT COMPOSITIONS THAT INCLUDE CERTAIN ALKOXYLATED PEI POLYMERS

(71) Applicant: The Procter & Gamble Company, Cincinnati, OH (US)

(72) Inventor: Zhe XIANG, Cincinnati, OH (US)

(21) Appl. No.: 15/828,983

(22) Filed: Dec. 1, 2017

(51) Int. Cl. C11D 11/00; C11D 13/10; C11D 17/08; C11D 3/37; C11D 3/386; C11D 3/395; C11D 3/42; C11D 1/14

(52) U.S. Cl. CPC C11D 11/0082; C11D 11/0064; C11D 13/10; C11D 17/08; C11D 1/146; C11D 3/38663; C11D 3/395; C11D 3/42; C11D 1/143; C11D 3/3723

(57) ABSTRACT

Processes of making liquid detergent compositions that include certain alkoxylated polyethyleneimine (PEI) polymers.

### FIELD OF THE INVENTION

The present disclosure relates to processes of making liquid detergent compositions that include certain alkoxylated polyethyleneimine polymers.

### BACKGROUND OF THE INVENTION

To save space and capital investment, detergent manufacturers may use the same manufacturing equipment to make multiple products. These products may be somewhat similar and even be produced with from the same base composition, but the final products can have different ingredients and/or different levels of ingredients.

However, producing a second product on the same manufacturing line where a first product was already made can result in contamination of the second product with components of the first. The contaminating components, even at low levels, may have undesirable and/or surprising consequences on the final product.

For example, it has been found that low levels of certain alkoxylated polyethyleneimine (PEI) polymers can have a significant effect on viscosity of resulting liquid detergent products. This can result in undesirable product variability as initial products in a manufacturing run will include the contaminating polymer, while products made later in the run will not.

A manufacturing line may be flushed with a fluid between the production of a first product and a second product in order to remove potentially contaminating PEI polymers from the line. However, such flushing can take time and may result in waste product.

Furthermore, when the PEI polymer is included in a liquid base composition, a second base composition is required to make a second product that is free of the offending PEI polymer.

There is a need for improved processes of making detergent products that contain (as well as those that do not contain) certain PEI polymers.

### SUMMARY OF THE INVENTION

The present disclosure relates to processes of making liquid detergent compositions that include certain alkoxylated polyethyleneimine polymers.

For example, the present disclosure relates to a process of making a liquid detergent composition, the process comprising the steps of: providing a manufacturing line comprising, in series and in fluid communication, an upstream region, a confluence region, and a downstream region; providing a liquid base composition at the upstream region, the liquid base composition comprising at least one surfactant and at least one detergent adjunct; and combining the liquid base composition with an alkoxylated polyethyleneimine (PEI) polymer in the confluence region, thereby resulting in a detergent composition at the downstream region, wherein the alkoxylated PEI polymer comprises, on an average molar basis, from about 5 to about 50 ethoxy (EO) groups per alkoxylated nitrogen, and from about 1 to about 20 propoxy (PO) groups per alkoxylated nitrogen.

Processes according to the present disclosure may include steps where a first amount of the liquid base composition is provided at the upstream region and the detergent composition is a first detergent composition, providing a second amount of the liquid base composition at the upstream region of the manufacturing line, and combining the liquid base composition with at least one additional detergent adjunct, resulting in a second detergent composition at the downstream region, wherein none of the alkoxylated PEI polymer is affirmatively added to second detergent composition. At least a portion of the manufacturing line may be flushed with a flowable/liquid composition between making the first detergent composition and the second detergent composition.

### BRIEF DESCRIPTION OF THE DRAWINGS

The figures herein are illustrative in nature and are not intended to be limiting.

FIG. 1 shows a schematic illustration of the processes of the present disclosure.

FIG. 2 shows a schematic illustration of the processes of the present disclosure, including optional addition of adjunct ingredients.

FIG. 3 shows a schematic illustration of the processes of the present disclosure, including the step of storing a base composition in a storage container.

FIG. 4 shows the viscosity differences in different detergent samples made from a single manufacturing run, as described in Example 1 below.

FIG. 5 shows the viscosity differences of a detergent product contaminated at various levels by different PEI polymers, as described in Example 3 below.

### DETAILED DESCRIPTION OF THE INVENTION

The present disclosure relates to processes of making liquid detergent compositions. In brief, a liquid base composition comprising at least one surfactant and at least one detergent adjunct is provided on a manufacturing line, and is then combined with certain alkoxylated polyethyleneimine polymers, resulting in a liquid detergent composition.

In some detergent manufacturing processes, certain alkoxylated polyethyleneimine (PEI) polymers that include ethoxylate (EO) and propoxylate (PO) groups are provided in a liquid base composition. Adjunct materials are added to this liquid base, resulting in final detergent products.

However, it has been found that these certain alkoxylated (EO/PO) PEI polymers can have a surprising effect on liquid detergent compositions, such as decreasing their viscosity to an unexpected degree. When multiple detergent products are made on a single manufacturing line, residual alkoxylated PEI polymer may be left over from a first detergent product and may contaminate a second detergent product, resulting in variable viscosity and/or poor quality control.

Furthermore, it has also been surprisingly found that not all alkoxylated PEI polymers have the same viscosity-altering effect on liquid detergent products. Without wishing to be bound by theory, it is believed that the particular molar amounts and/or configuration of the EO and PO groups of the PEI polymers in question contribute to the viscosity-altering properties of the polymer.

Thus, instead of initially including the disclosed alkoxylated PEI polymers in a liquid base composition, the subject matter of the present disclosure relates to combining the polymer with a liquid base composition on a manufacturing line. When the two materials are combined relatively late in the manufacturing process, less of the manufacturing line will be contaminated with the PEI polymer, meaning that the line will be relatively easier to clean and/or such cleaning will produce less waste compared to if the PEI polymer were included in the liquid base composition.

Alternatively, a relatively small amount of the disclosed PEI may be included in the base composition, where it may reduce the viscosity of the base and make it easier to pump and/or deaerate. Additional amounts of the disclosed PEI may then be added later in the process, providing the manufacturer with formulation flexibility, as it may be desirable for some products to have more PEI polymer than others.

The process and compositions of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein, the phrase “surface care composition” means a composition suitable for treating a surface. Suitable surfaces to be treated may include textiles such as fabrics, including articles to be laundered; hard surfaces such as dishware (including glassware and flatware), countertops, tile and other hard flooring, and bathroom fixtures such as sinks, toilets, and bathtubs/showers; hair; and skin. Surface care compositions may include fabric care compositions, dish care compositions, hard surface cleaning compositions, hair care compositions, skin care compositions, or mixtures thereof.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein, the phrase “propoxy group” means a propylene oxide group and may be shortened to a “PO group” or just “PO.”

As used herein, the phrase “ethoxy group” means an ethylene oxide group and may be shortened to an “EO group” or just “EO.”

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Method of Making

The present disclosure relates to a process of making a liquid detergent composition. The liquid detergent composition may be a household care composition, as described in more detail below.

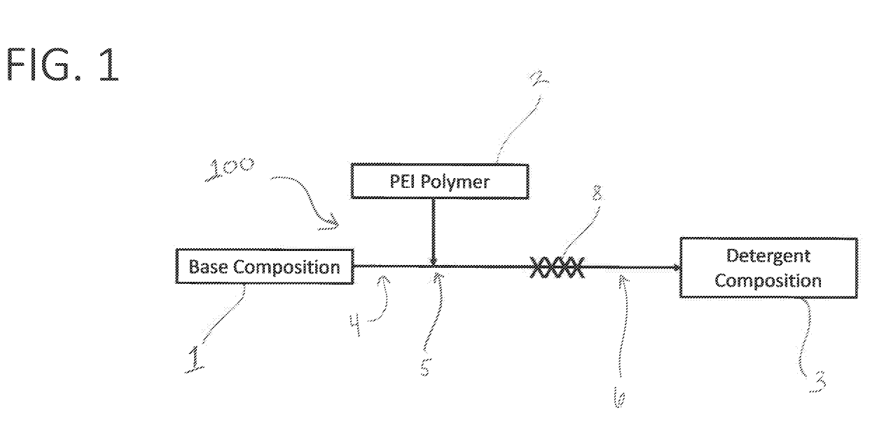

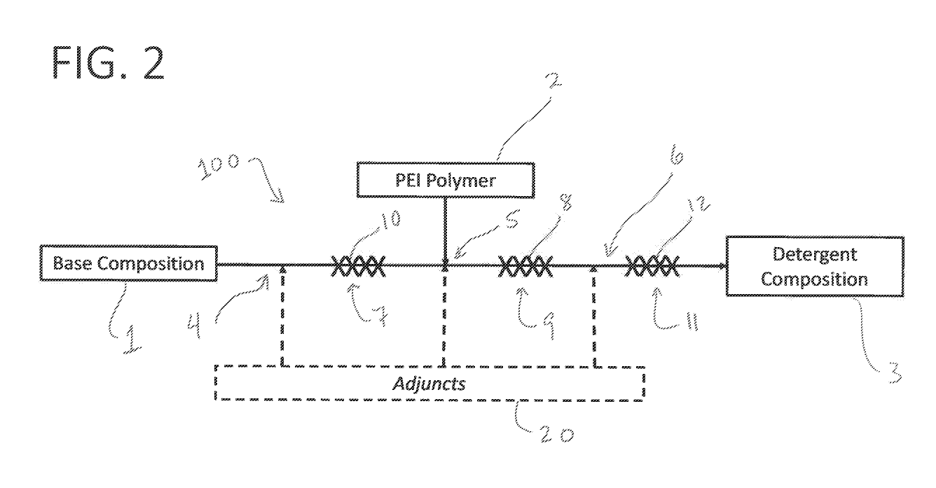

As shown schematically in FIGS. 1 and 2, the present processes may include providing a manufacturing line 100 suitable for manufacturing a liquid detergent composition 3. The manufacturing line may include, preferably in series, an upstream region 4, a confluence region 5, and a downstream region 6. The regions 4, 5, 6 may be in fluid communication with one another, for example so that a fluid may travel from the upstream region 4, to the confluence region 5, to the downstream region 6. The process may include the step of providing a base composition 1 at the upstream region 4, combining the liquid base composition 1 with a polyethyleneimine polymer 2, in the confluence region 5, and thereby resulting in a detergent composition 3 at the downstream region 6. A mixer, such as a static mixer 8, may be present relatively downstream of the confluence region 4 and/or relatively upstream of the detergent composition 3.

As schematically shown in FIG. 2, the processes of the present disclosure may further include the step(s) of adding one or more additional detergent adjuncts 20 to the liquid base composition 1, the detergent composition 3, or both. The adjuncts may be added in the upstream region 4, the confluence region 5, or the downstream region 6. The resulting compositions may be mixed in mixing zones 7, 9, 11, for example with static mixers 8, 10, 12.

The manufacturing line 100 may include, for example, a pipe, a mixing vessel, and/or a conveyor system.

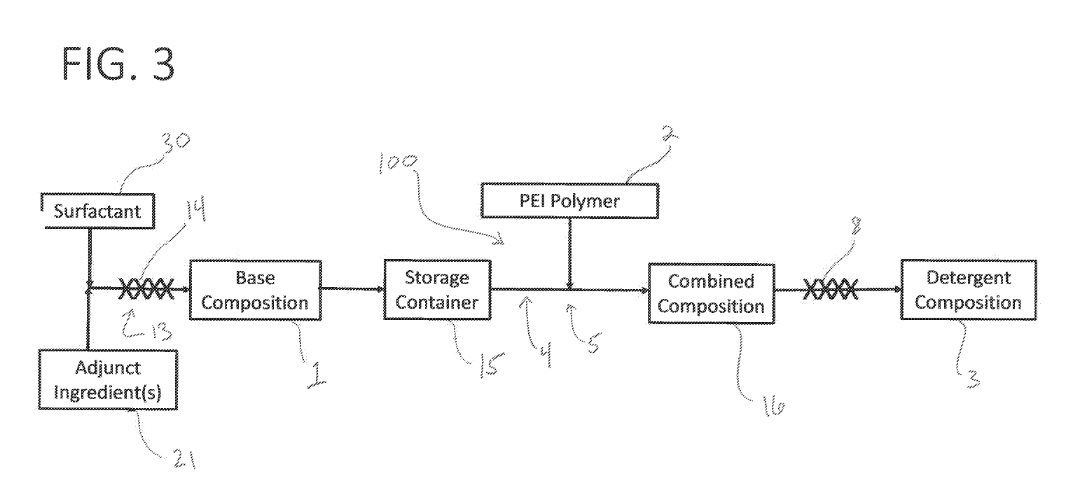

As shown schematically in FIG. 3, the present processes may include providing a base composition 1 in a storage container 15, such as a storage tank. The container 15 may be suitable for industrial usage and may have an interior volume of from about 1000 L to about 1,000,000 L, or from about 5000 L to about 500,000 L. The base composition 1 may have a residence time in the storage container 15. The residence time may be selected so that the base composition 1 can sufficiently de-aerate. Typically, it is preferred that the time for de-aeration is kept to a minimum. The residence time may be at least about twelve hours. The residence time may be no longer than about seventy-two hours, or no longer than about forty-eight hours, or no longer than about twenty-four hours. The present processes may include the step of moving, for example by pumping, at least a portion of the base composition 1 from the storage container 15 to the upstream region 4 of the manufacturing line 100 described above.

The processes of the present disclosure may further include a filling step. The filling step may include placing the detergent composition into a container, which may occur at a location on the manufacturing line further downstream of the downstream region. The filling step may occur less than about ten minutes after the zwitterionic surfactant, such as amine oxide surfactant, is added to the liquid base composition. The container of the filling step may be a pouch or a bottle, which may be suitable for selling to a consumer. Multiple containers may be packaged into secondary packaging, such as in box or on a pallet.

The steps, compositions, and component ingredients of the present disclosure are described in more detail below.

### Base Composition

The present processes may include the step of providing a liquid base composition. The components of the liquid base composition are suitable for inclusion in the final household care composition(s).

The liquid base composition may be partially or completely prepared and stored prior to beginning making the liquid detergent compositions of the present disclosure. The liquid base composition may be stored and then later modified by adding adjunct ingredients, prior to combining the base composition with the alkoxylated PEI polymer. The liquid base composition may be made during an in-line process prior to combining the base composition with the PEI polymer.

As shown in FIG. 3, the processes of the present disclosure may include the step of preparing the liquid base composition 1 by combining at least one surfactant 30 and at least one detergent adjunct 21 and mixing. Suitable surfactants and adjuncts are described in more detail below. The mixing step may be via any suitable mixing process, or with any suitable mixing apparatus. For example, the mixing process may be a batch mixing process, or an in-line mixing process. The mixing process may comprise dynamic mixing and/or static mixing in a mixing zone 13, for example via the use of static mixers 14.

The liquid base composition may be stored, e.g. in a storage tank, for at least six hours, or at least twelve hours, or at least eighteen hours, or at least twenty-four hours, and optionally up to forty-eight hours, or up to seventy-two hours, prior to the step of being combined with PEI polymer.

As shown in FIG. 3, the liquid base composition 1 may be stored in a storage container 15 and then transported, e.g., by pumping through one or more pipes, to where the base composition 1 will be combined with the PEI polymer 2 to form a combined composition 16, which may be mixed, e.g., by a static mixer 8. The liquid base composition 1 may be provided at an upstream region 4 of a manufacturing line 100.

The liquid base composition may be provided as a first amount and a second amount. The first and second amounts may be any suitable volume for the amount of resulting household care composition that is desired. For example, the volume may be sufficient to fill a single bottle (e.g., 1 liter) or sufficient to run a manufacturing line at full capacity for one or more days (e.g., 1000s of liters or more).

The liquid base composition may be characterized by a viscosity, determined according to the test method described below. The liquid base composition may have a viscosity, which may be a first viscosity, of less than about 1500 cps, or less than about 1000 cps, or less than about 800 cps, or less than about 500. The liquid base composition may have a first viscosity that is from about 50 to about 300 cps.

The liquid base composition may be characterized by a pH of from about 2 to about 12. The liquid base composition may be characterized by a basic pH, for example a pH of from about 7.5, or from about 8, or from about 9, or from about 10, to about 12, or to about 11, or to about 10. The liquid base composition may be characterized by a pH of from about 9 to about 12, or from about 8 to about 9. The liquid base composition may be characterized by an acidic pH.

The liquid base composition may be substantially unbuffered. The liquid base composition may be substantially free of buffering agents, such as citric acid, acetic acid, lactic acid, a borate derivative, fatty acid, alkanolamine, a caustic hydroxide compound (e.g., NaOH), a carbonate, a zeolite, or mixtures thereof. As used herein, the liquid base composition may be substantially free of buffering agents, other than compounds present in amounts necessary to neutralize acid-forms of the present surfactants.

The liquid base composition may include detersive surfactant. The base composition may include from about 1%, or from about 5%, or from about 10%, or from about 15%, or from about 20%, and optionally up to about 75%, or up to about 60%, or up to about 50%, or up to about 40%, or up to about 30%, or up to about 25%, by weight of the base composition, of detersive surfactant. The liquid base composition may include from about 15% to about 30% of detersive surfactant.

The detersive surfactant may be selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material. As used herein, fatty acids and their salts are understood to be part of the surfactant system.

The detersive surfactant may include anionic surfactant. Anionic surfactant may be present in the largest proportion of all the surfactants present in the base composition. Non-limiting examples of suitable anionic surfactants include any conventional anionic surfactant.

This may include a sulfate detersive surfactant, for e.g., alkoxylated and/or non-alkoxylated alkyl sulfate materials, and/or sulfonic detersive surfactants, e.g., alkyl benzene sulfonates. The liquid base composition may comprise anionic surfactant selected from alkyl alkoxylated sulfate, alkyl sulfate, alkyl benzene sulphonate, or mixtures thereof. The surfactant may comprise alkyl ethoxylated sulfate and alkyl benzene sulphonate.

Suitable anionic surfactants may be derived from renewable resources, waste, petroleum, or mixtures thereof. Suitable anionic surfactants may be linear, partially branched, branched, or mixtures thereof.

The anionic surfactants may exist in an acid form, and the acid form may be neutralized to form a surfactant salt. Typical agents for neutralization include metal counterion bases, such as hydroxides, e.g., NaOH or KOH. Further suitable agents for neutralizing anionic surfactants in their acid forms include ammonia, amines, or alkanolamines. Non-limiting examples of alkanolamines include monoethanolamine, diethanolamine, triethanolamine, and other linear or branched alkanolamines known in the art; suitable alkanolamines include 2-amino-1-propanol, 1-aminopropanol, monoisopropanolamine, or 1-amino-3-propanol. Amine neutralization may be done to a full or partial extent, e.g., part of the anionic surfactant mix may be neutralized with sodium or potassium and part of the anionic surfactant mix may be neutralized with amines or alkanolamines.

The detersive surfactant may include nonionic surfactant. Suitable nonionic surfactants include alkoxylated fatty alcohols. The nonionic surfactant may be selected from ethoxylated alcohols and ethoxylated alkyl phenols of the formula R(OC₂H₄)ₙ—OH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

Other non-limiting examples of nonionic surfactants useful herein include: C₈-C₁₈ alkyl ethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA; C₁₄-C₂₂ mid-chain branched alkyl alkoxylates, BAEₓ, wherein x is from 1 to 30; alkylpolysaccharides; specifically alkylpolyglycosides; polyhydroxy fatty acid amides; and ether capped poly(oxyalkylated) alcohol surfactants.

The detersive surfactant may include a cationic surfactant. Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, e.g., amido propyldimethyl amine (APA). Suitable cationic detersive surfactants also include alkyl pyridinium compounds, alkyl quaternary ammonium compounds, alkyl quaternary phosphonium compounds, alkyl ternary sulphonium compounds, and mixtures thereof. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

The detersive surfactant may include a zwitterionic surfactant. Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. Suitable examples of zwitterionic surfactants include betaines, including alkyl dimethyl betaine and cocodimethyl amidopropyl betaine, amine oxides (for example C₈ to C₁₈, or C₁₂ to C₁₈) amine oxides, and sulfo and hydroxy betaines, such as N-alkyl-N,N-dimethylammino-1-propane sulfonate where the alkyl group can be C₈ to C₁₈.

The zwitterionic surfactant may be amine oxide surfactant. Suitable amine oxides may include alkyl dimethyl amine oxide or alkyl amido propyl dimethyl amine oxide, more preferably alkyl dimethyl amine oxide and especially coco dimethyl amino oxide Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3) O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein.

The amine oxide may further comprise two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

The detersive surfactant may include an amphoteric surfactant. Examples of amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof.

The liquid base composition may include other ingredients, such as water, nonaminofunctional solvent, and/or additional adjunct ingredients.

The liquid base composition may comprise water, for example from about 10%, or from about 20%, or from about 25%, or from about 35%, to about 80%, or to about 75%, or to about 70%, or to about 60%, or to about 50%, by weight of the liquid base composition, of water.

The liquid base composition may comprise non-aminofunctional organic solvent. As used herein, “non-aminofunctional organic solvent” refers to any suitable organic solvent which contains no amino functional groups. Suitable non-aminofunctional organic solvents may include monohydric alcohols, dihydric alcohols, polyhydric alcohols, glycerol, glycols, polyalkylene glycols such as polyethylene glycol, and mixtures thereof. The compositions of the present disclosure may include mixtures of solvents, such as mixtures of two or more of the following: lower aliphatic alcohols such as ethanol, propanol, butanol, isopropanol; diols such as 1,2-propanediol or 1,3-propanediol; and glycerol. The compositions of the present disclosure may include solvents that include propanediols but not methanol and/or ethanol. The non-aminofunctional organic solvents may be liquid at ambient temperature and pressure (i.e. 21° C. and 1 atmosphere), and may comprise carbon, hydrogen and oxygen. Non-aminofunctional organic solvents may also be added as adjunct ingredients according to the present processes. The liquid base composition may include no more than about 15%, or not more than about 10%, or no more than about 5%, by weight of the liquid base composition, of non-aminofunctional organic solvent. It may be desirable to limit the amount of solvent in the base composition, as such solvents provide little performance benefit in final product.

The liquid base composition may include additional adjunct ingredients, as described below. For example, the liquid base composition may include a PEI polymer, which may be the same or different as the EO/PO alkoxylated PEI polymer described below. The liquid base composition may include a second PEI polymer that is different than the EO/PO alkoxylated PEI polymer described below; the second PEI polymer may be an ethoxylated PEI polymer, as described in more detail below.

### Alkoxylated Polyethyleneimine Polymer

The processes and compositions of the present disclosure relate to alkoxylated polyethyleneimine (PEI) polymers. The polymers described herein are known to deliver cleaning and/or whitening benefits, for example soil anti-redeposition benefits.

The processes of the present disclosure may include a step of combining a liquid base composition with an alkoxylated polyethyleneimine (PEI) polymer. As shown in FIGS. 1-3, the processes of the present disclosure may include providing a liquid base composition 1 and combining the liquid base composition 1 with the alkoxylated PEI polymer 2.

The processes of the present disclosure may include combining a portion of the liquid base composition 1 with an alkoxylated PEI polymer 2 to form a combined composition 16. The processes may include mixing the combined composition 16, which may result in a detergent composition 3. The mixing step may occur in a mixing zone 7 and may include any suitable mixing apparatus, including one or more static mixers 8.

This combining step may occur in the confluence region 5 of a manufacturing line 100. A liquid detergent composition 3 may result at a downstream region 6 of the manufacturing line 100.

The alkoxylated PEI polymer that is combined with the base detergent may be in the form of an aqueous solution. The aqueous solution may include water and the alkoxylated PEI polymer, where the alkoxylated PEI polymer is present at a level of from about 10% to about 50%, or from about 20% to about 40%, by weight of the aqueous solution, of amine oxide. The alkoxylated PEI polymer may be combined with other organic solvents, but water is typically preferred, for cost and/or volatility reasons.

The alkoxylated PEI polymer may be combined with the liquid base composition in an amount suitable to provide from about 0.01%, or from about 0.05%, or from about 0.1%, or from about 0.5%, or from about 0.8%, or from about 1.0%, or from about 1.5%, to about 2%, or to about 2.5%, or to about 3%, or to about 5%, or to about 10%, or to about 15%, or to about 20%, by weight of the final detergent composition, of alkoxylated PEI polymer in the final detergent composition. The detergent composition may comprise from about 0.1% to about 2%, or from about 0.2% to about 1.5%, or from about 0.4% to about 1.2%, or from about 0.5% to about 1%, by weight of the composition of the alkoxylated PEI. The detergent compositions may comprise mixtures of alkoxylated PEI polymers.

The alkoxylated PEI polymer may have a weight average molecular weight of from about 200 to about 60,000, or to about 20,000, or to about 10,000. In some aspects, the weight average molecular weight is from about 350 to about 5000, or to about 2000, or to about 1000.

The alkoxylated PEI polymers typically include a polyethyleneimine (PEI) backbone. The PEI backbone may be characterized by a weight average molecular weight, prior to alkoxylation, of from about 200 to about 1500, or of about 400 to about 1000, or of about 500 to about 800, or of about 600.

The PEI backbones of the alkoxylated PEI polymers described herein, prior to alkoxylation, may have the general empirical formula:

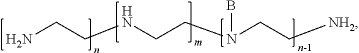

where B represents a continuation of this structure by branching. The sum of n+m may be equal to or greater than 8, or 10, or 12, or 14, or 18, or 22.

In the PEI backbones, each hydrogen atom attached to each nitrogen atom represents an active site for possible subsequent alkoxylation. The PEIs used in preparing some suitable compounds can have a weight average molecular weight of at least about 600 prior to alkoxylation, which represents at least about 14 ethyleneimine units.

The alkoxylated PEI polymers may include alkoxylated nitrogens. The alkoxylated nitrogens may include both C3 propoxy (PO) groups and C2 ethoxy (EO) groups. The PO and EO groups may form an alkoxylate unit.

The alkoxylate unit may be a non-random sequence of alkoxylate blocks. For example, during synthesis of the alkoxylated PEI polymer, the EO groups may be added first, meaning they will be more closely positioned to the alkoxylated nitrogen, and the PO groups may be added second. This particular orientation provides an alkoxylated PEI with an inner polyethylene oxide block and an outer polypropylene oxide block.

On an average molar basis, the alkoxylated PEI may include from about 10 to about 50, preferably from about 15 to about 40, more preferably from about 20 to about 30 ethoxy groups per alkoxylated nitrogen.

On an average molar basis, the alkoxylated PEI may include from about 1 to about 50, preferably from about 5 to about 40, and more preferably from about 10 to about 30 propoxy groups per alkoxylated nitrogen. The alkyl portion of the PO group may be 1,2-propylene.

The alkoxylate unit may additionally include a small proportion of C4 butyleneoxy (BO) groups, for example, from about more than zero to about three BO groups per alkoxylated nitrogen. The BO groups may comprise 1,2-butylene and/or 1,2-isobutylene.

The alkoxylated polyalkyleneimine may have a polyalkyleneimine core with a weight average molecular weight (prior to alkoxylation) ranging from about 100 to about 5000 Daltons, or from about 200 to about 1000 Daltons, where on an average molar basis, the alkoxylate units of the alkoxylated PEI include an inner EO block that includes from about 10 to about 50, preferably from about 15 to about 40, more preferably from about 20 to about 30 EO groups and an outer PO block that includes from about 1 to about 50, preferably from about 5 to about 40, and more preferably from about 10 to about 30 PO groups. Suitable alkoxylated PEIs may include those that can be represented by an empirical formula of (PEI)₁₀₀₋₅₀₀₀(EO)₁₀₋₅₀(PO)₁₋₅₀, or (PEI)₂₀₀₋₁₀₀₀(EO)₂₀₋₃₀(PO)₁₀₋₃₀.

In the alkoxylate units of the alkoxylated PEI polymers, the ratio of the molar average number of EO groups to the molar average number of PO groups may be from about 0.5, or from about 1, to about 5, or to about 4, or to about 3, or to about 2, and/or the ratio may be about 1.5.

The alkoxylated PEI polymer may quaternized, and may be characterized by a degree of quaternization ranging from 0 to about 50.

Suitable alkoxylated PEI polymers may be characterized by the following structure:

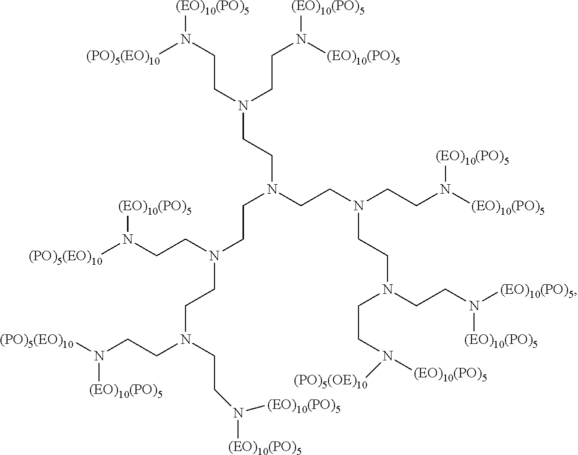

where EOs are ethoxylate groups and POs are propoxylate groups (e.g., 10 EO: 5 PO). Other suitable PEI polymers include those having structures similar to those above, with molar ratios of from about 20-30 EO groups to about 10-30 PO groups, or a ratio of about 24 EO groups:about 16 PO groups.

Suitable alkoxylated PEI polymers may include those described in U.S. Pat. No. 8,097,579, incorporated herein by reference. Alkoxylated PEI polymers may be provided by BASF SE (Ludwigschafen, Germany). A suitable alkoxylated PEI may be PEI600 EO24 PO16.

While the present disclosure relates to process in which the described PEI polymer is added to a liquid base composition, the liquid base composition may comprise at least some ethoxylated/propoxylated PEI polymer, as described herein. For example, as shown below, the disclosed PEI polymers may decrease the viscosity of certain compositions. It may be desirable to decrease the viscosity of the liquid base composition, for example, to make it easier to pump and/or quicker to deaerate. It may be further desirable to modify the viscosity with an active agent such as the PEI polymers described herein, rather than solvents or other viscosity modifying agents that do not provide much in the way of performance benefits. The liquid base compositions may comprise from about 0.05% to about 2%, or to about 1.5%, or to about 1%, or to about 0.5%, or to about 0.3%, or to about 0.2%, or to about 0.1%, by weight of the liquid base composition, of ethoxylated/propoxylated PEI polymer, which may be of the same type of alkoxylated PEI as is added to the liquid base composition according to the presently disclosed processes. The relative level (by weight %) of PEI polymer present in the liquid base composition may be less than the relatively level (by weight %) of PEI polymer present in the liquid detergent composition formed from the processes described herein.

### Liquid Detergent Composition

The processes of the present disclosure may result in a liquid detergent composition. For example, combining a liquid base composition 1 with an alkoxylated PEI polymer 2 as described herein, for example, in a confluence region 5 of a manufacturing line 100, may result in a detergent composition 3, for example at a downstream region 6 of the manufacturing line. A liquid detergent composition 3 may result from mixing a combined composition 16, the combined composition 16 resulting from combining the liquid base composition 1 and the alkoxylated PEI polymer 2.

The liquid detergent composition may be liquid surface care compositions, such as fabric care compositions, dish care compositions, hard surface cleaner compositions, hair care compositions, skin care compositions, or mixtures thereof. The liquid detergent compositions of the present disclosure may be fabric care compositions, dish care compositions, or mixtures thereof. The dish care compositions may be dish care compositions suitable for hand-washing and/or for washing in an automatic dishwasher.

The liquid detergent compositions of the present disclosure may include additional adjunct ingredients. These ingredients may be present in the liquid base composition as provided, or they may be added during the processes described herein. The processes of the present disclosure may include the step(s) of adding one or more additional detergent adjuncts to the liquid base composition, to the detergent composition, or to both. For example, adjunct ingredients may be added before, during, or after the alkoxylated PEI polymer has been combined with the base composition. FIG. 2, for example, schematically shows that adjunct ingredients 20 may be optionally added before or after the alkoxylated PEI polymer 2 is combined with the base composition 3.

Any adjunct ingredient suitable for the final form and intended end-use of the described household care compositions may be added at any suitable point of the present processes. The adjunct ingredients may be added at a level suitable to provide a performance benefit. The adjunct ingredients may be present, individually or collectively, in the compositions of the present disclosure at a level of from about 0.00001%, or from about 0.0001%, or from about 0.001%, or from about 0.01%, or from about 0.1%, or from about 1%, to about 50%, or to about 40%, or to about 30%, or to about 20%, or to about 15%, or to about 10%, or to about 8%, or to about 6%, or to about 5%, or to about 4%, or to about 3%, or to about 2%, or to about 1%, by weight of the composition. The adjunct ingredient may be present at a level of from about 0.001% to about 10%, by weight of the composition.

The liquid household care compositions described herein may include one or more of the following non-limiting list of ingredients: fabric care benefit agent; detersive enzyme; deposition aid; rheology modifier; builder; chelant; bleach; bleaching agent; bleach precursor; bleach booster; bleach catalyst; perfume and/or perfume microcapsules; perfume loaded zeolite; starch encapsulated accord; polyglycerol esters; whitening agent; pearlescent agent; enzyme stabilizing systems; scavenging agents including fixing agents for anionic dyes, complexing agents for anionic surfactants, and mixtures thereof; optical brighteners or fluorescers; polymer including but not limited to soil release polymer and/or soil suspension polymer; dispersants; antifoam agents; non-aqueous solvent; fatty acid; suds suppressors, e.g., silicone suds suppressors; cationic starches; scum dispersants; substantive dyes; colorants; opacifier; antioxidant; hydrotropes such as toluenesulfonates, cumenesulfonates and naphthalenesulfonates; color speckles; colored beads, spheres or extrudates; clay softening agents; anti-bacterial agents. Additionally or alternatively, the compositions may comprise surfactants, quaternary ammonium compounds, and/or solvent systems. Quaternary ammonium compounds may be present in fabric enhancer compositions, such as fabric softeners, and comprise quaternary ammonium cations that are positively charged polyatomic ions of the structure NR₄⁺, where R is an alkyl group or an aryl group.

The compositions disclosed herein may comprise an adjunct selected from the group consisting of a structurant, a builder, an organic polymeric compound, an enzyme, an enzyme stabilizer, a bleach system, a brightener, a hueing agent, a chelating agent, a suds suppressor, a conditioning agent, a humectant, neat perfume, encapsulated benefit agent (such as perfume encapsulates), a filler or carrier, and mixtures thereof. The compositions of the present disclosure may comprise an adjunct selected from encapsulates, neat perfume, enzymes, fabric hueing agents, conditioning agents, fabric enhancement polymers, pearlescent agents, opacifiers, or mixtures thereof.

The compositions of the present disclosure may further comprise a structurant or thickener which may be useful to maintain the non-homogeneity of the present compositions, e.g., by “locking” the components into place. Structurants may also be useful to maintain stability and/or to suspend benefit agents. Suitable structurants/thickeners may include non-polymeric crystalline hydroxyl-functional materials, such as a crystallizable glyceride (e.g., hydrogenated castor oil or derivatives thereof). It may be that the base composition does not comprise an external structurant.

The liquid detergent composition may comprise at least a second alkoxylated PEI polymer in addition to the alkoxylated PEI polymer described above. The second alkoxylated PEI polymer may be a non-propoxylated PEI polymer, meaning that it may be free of propoxy groups. The second alkoxylated PEI polymer may be an ethoxylated PEI polymer and may include only ethoxy groups. The second alkoxylated PEI polymer may be an ethoxylated PEI polymer having between about 15 and 25, preferably about 20, ethoxy groups per alkoxylated nitrogen. The second alkoxylated PEI polymer may have a PEI backbone having a weight average molecular weight, prior to alkoxylation, of from about 500 to about 1000, or from about 550 to about 700, or about 600. The second alkoxylated PEI polymer may have a PEI backbone having a weight average molecular weight of about 600 (prior to alkoxylation) and about 20 EO groups per alkoxylated nitrogen. The second alkoxylated PEI polymer may be present in the liquid base composition and/or added to the liquid base composition.

The liquid detergent composition may be characterized by a pH. The pH may be an acidic pH or a basic pH, preferably a basic pH. The pH may be from about 7.5 to about 11, or to about 10, or to about 9, or to about 8.5. The pH of the liquid detergent composition may be different from the pH of the liquid base composition, preferably less than the pH of the liquid base composition. A buffering agent may be present in the base composition, added to the base composition before the alkoxylated PEI polymer, or may be added to the detergent composition after the alkoxylated PEI polymer has been combined with the base composition. Suitable buffering agents are described above.

The processes of the present disclosure may include one or more finishing steps, in which certain adjunct ingredients are added, e.g., downstream from the confluence zone, after the base composition has been combined with the alkoxylated PEI polymer, to result in the final household care composition(s). For example, the finishing step may comprise adding aesthetic ingredients, such as neat perfume and/or (aesthetic) dye. The finishing step may include adding encapsulated benefit agents, such as perfume encapsulates; a structuring agent may be added before or after the encapsulated benefit agent is added, preferably after. The finishing step may comprise mixing the household care composition, for example, with a static mixer.

The liquid detergent compositions of the present disclosure may include at least about 50%, or at least about 60%, or at least about 70%, or at least about 75%, or at least about 80%, by weight of the composition, of water.

The processes of the present disclosure may include a filling step. The filling step may include disposing at least a portion of the household care compositions in a container. The process may include a filling step where the detergent composition is placed into a container at a location further downstream of the downstream region, preferably wherein the filling step occurs less than about 10 minutes after the alkoxylated PEI polymer is added to the liquid base composition. The container may be a storage container (such as a storage tank), a transport container (for example, a rail car), or a container suitable for sale to a consumer, such as a vendable bottle or bag. Multiple containers may be bundled for transport, such as multiple bottles in a box or on a pallet.

The processes of the present disclosure also contemplate making a plurality of liquid detergent compositions, including at least a first detergent composition and a second detergent composition, wherein the first and second detergent compositions are compositionally different. It may be advantageous to the manufacturer to begin with a single base composition and then add different types and/or amounts of ingredients to form at least two different types of detergents, as starting with a single base composition may reduce complexity and/or capital requirements.

For example, the process may include the steps of providing a first portion of the base composition at the upstream region and combining the first portion with an alkoxylated PEI polymer, thereby resulting in a first detergent composition. The process may further include providing a second portion of the base composition and adding at least one additional detergent adjunct, resulting in a second detergent composition at the downstream region, where the second detergent composition is compositionally different from the first detergent composition. The second detergent may be made compositionally different, for example, by providing a different amount of alkoxylated PEI polymer (more, less, or even none at all) to the second portion of base detergent as compared to the first portion. Typically, the second detergent is substantially free of, or does not include any of, the alkoxylated PEI polymer that was added to form the first detergent composition. The second detergent composition may be made by a process where none of the alkoxylated PEI polymer is affirmatively added. In such cases, the alkoxylated PEI polymer is not intentionally added, although small amounts may be present in the second detergent composition as a result of residual contamination from the process of making the first detergent composition.

Additionally or alternatively, the second detergent may be made compositionally different by providing different types and/or amounts of surfactants, adjunct ingredients, or mixtures thereof to the second portion of the base composition and/or to the second detergent composition. For example, different perfume and/or perfume encapsulates may be added to the second detergent composition.

The process of the present disclosure may include a flushing step, wherein at least a portion of the manufacturing line is flushed with a flowable composition, such as a liquid composition, between making the first detergent composition and making the second detergent composition. Flushing the line may help to remove materials that are residually present from the process of making the first detergent composition, where the presence of such materials are not desired in the second detergent, or where it is desired that the levels of the materials are more tightly controlled. For example, as described herein, even residual amounts of the described alkoxylated PEI polymer can impact the viscosity of later-made detergent compositions.

The flowable and/or liquid composition used for the flushing step may comprise the liquid base composition, or it may be water and/or an organic solvent. The flowable/liquid composition may include detersive surfactant. The flowable/liquid composition may be free of the alkoxylated PEI polymer.

At least a portion of the flowable/liquid composition may be captured after being flushed through the manufacturing line. The portion that is captured may be combined with the liquid base composition and/or liquid detergent compositions that are made after the first detergent compositions, for example, second detergent compositions. Such capture and/or reblend may be useful to reduce waste, particularly if the flowable/liquid composition used to flush the line comprises surfactant and/or the liquid base composition.

The manufacturing line may be characterized by a linear distance over which the described compositions flow. For example, the linear distance may be characterized as from the upstream region, such as where the liquid base composition is provided to the manufacturing line, through the confluence region, to the downstream region, for example to where the filling step occurs. The alkoxylated PEI polymer may be combined with the liquid base composition within the final 50%, or within the final 40%, or within the final 30%, or within the final 20%, of the linear distance of the manufacturing line. Combining the alkoxylated PEI polymer with the liquid base composition over the described final portion of the linear distance of manufacturing line means that only a portion of the manufacturing line may need to be flushed, thereby saving time, energy, and/or the amount of flowable/liquid composition required for the flushing process.

The processes of the present disclosure may include making at least a third detergent composition on the manufacturing line. The line may be flushed with a flowable/liquid composition between the making of the second detergent composition and the making of the third detergent composition. The formulation of the third composition may be substantially the same, or even the same, as the formulation of the first composition. The step of making the third detergent composition may include providing a third amount of the liquid base composition and combining it with the alkoxylated PEI polymer having the PO and EO groups as described herein.

### Methods of Use

The household care compositions made by the present processes may be used for their intended end-use according to known methods. For example, fabric care compositions may be used to treat a fabric, for example by contacting a fabric with a wash liquor comprising water and a portion of the fabric care composition. Dish washing compositions may be used to treat, e.g., dirty dishes, glassware, and/or flatware by contacting the dishes, etc., with an aqueous mixture of water and the dish washing composition. Manual and automatic (e.g., with a suitable machine) treatment processes are contemplated by the present disclosure.

### Combinations

Specifically contemplated combinations of the disclosure are herein described in the following lettered paragraphs. These combinations are intended to be illustrative in nature and are not intended to be limiting.

A. A process of making a liquid detergent composition, the process comprising the steps of: providing a manufacturing line comprising, in series and in fluid communication, an upstream region, a confluence region, and a downstream region; providing a liquid base composition at the upstream region, the liquid base composition comprising at least one surfactant and at least one detergent adjunct; and combining the liquid base composition with an alkoxylated polyethyleneimine (PEI) polymer in the confluence region, thereby resulting in a detergent composition at the downstream region, wherein the alkoxylated PEI polymer comprises, on an average molar basis, from about 5 to about 50 ethoxy (EO) groups per alkoxylated nitrogen, and from about 1 to about 20 propoxy (PO) groups per alkoxylated nitrogen.

B. A process according to paragraph A, wherein the process further comprises adding one or more additional detergent adjuncts to the liquid base composition, the detergent composition, or both.

C. A process according to any of paragraphs A-B, wherein the at least one detergent adjunct comprises a builder, an organic polymeric compound, an enzyme, an enzyme stabilizer, a bleach system, a brightener, a hueing agent, a chelating agent, a suds suppressor, a conditioning agent, a humectant, neat perfume, encapsulated benefit agents, a filler or carrier, or mixtures thereof.

D. A process according to any of paragraphs A-C, wherein the liquid base composition comprises from about from about 1% to about 75%, by weight of the liquid base composition, of surfactant.

E. A process according to any of paragraphs A-D, wherein the surfactant comprises anionic surfactant selected from alkyl alkoxylated sulfate, alkyl sulfate, alkyl benzene sulphonate, or mixtures thereof.

F. A process according to any of paragraphs A-E, wherein the surfactant comprises alkyl ethoxylated sulfate and alkyl benzene sulphonate.

G. A process according to any of paragraphs A-F, wherein the alkoxylated PEI polymer is combined with the liquid base composition in an amount suitable to provide from about 0.01% to about 5%, by weight of the final detergent composition.

H. A process according to any of paragraphs A-G, wherein the alkoxylated PEI polymer comprises a PEI backbone characterized by a weight average molecular weight, prior to alkoxylation, of from about 200 to about 1500.

I. A process according to any of paragraphs A-H, wherein the alkoxylated PEI polymer comprises, on an average molar basis, from about 10 to about 50, or from about 15 to about 40, or from about 20 to about 30 ethoxy (EO) groups per alkoxylated nitrogen.

J. A process according to any of paragraphs A-H, wherein the alkoxylated PEI polymer comprises, on an average molar basis, from about 1 to about 50, or from about 5 to about 40, or from about 10 to about 30 propoxy (PO) groups per alkoxylated nitrogen.

K. A process according to any of paragraphs A-J, wherein the alkoxylated PEI polymer comprises alkoxylate units having an inner EO block and an outer PO block.

L. A process according to paragraph K, wherein the inner EO block comprises from about 10 to about 50 EO groups, and wherein the outer PO block comprises from about 1 to about 50 PO groups.

M. A process according to any of paragraph A-L, wherein the average molar ratio of EO groups to PO groups is from about 0.5 to about 5.

N. A process according to any of paragraphs A-M, wherein the detergent composition comprises the alkoxylated PEI polymer and at least a second alkoxylated PEI polymer.

O. A process according to any of paragraphs A-N, wherein the second alkoxylated PEI polymer is an ethoxylated PEI polymer.

P. A process according to any of paragraphs A-O, wherein the liquid base composition further comprises a PEI polymer, which may be the same as or different from the alkoxylated PEI polymer of paragraph A.

Q. A process according to any of paragraphs A-P, wherein the process further comprises a filling step, wherein the detergent composition is placed into a container at a location further downstream of the downstream region, preferably wherein the filling step occurs less than about 10 minutes after the alkoxylated PEI polymer is added to the liquid base composition.

R. A process according to any of paragraphs A-Q, wherein a first amount of the liquid base composition is provided at the upstream region and the detergent composition is a first detergent composition, and wherein the process further comprises the steps of providing a second amount of the liquid base composition at the upstream region of the manufacturing line, and combining the liquid base composition with at least one additional detergent adjunct, resulting in a second detergent composition at the downstream region, wherein none of the alkoxylated PEI polymer is affirmatively added to second detergent composition.

S. The process according to any of paragraphs A-R, wherein at least a portion of the manufacturing line is flushed with a flowable/liquid composition between making the first detergent composition and the second detergent composition.

T. The process according to any of paragraphs A-S, wherein at least a portion of the flowable/liquid composition is captured after being flushed through the manufacturing line, and optionally is combined with the liquid base composition and/or the second detergent composition.

### Test Methods

### Viscosity

The viscosity is measured with a viscometer, such as the Broofield RVD VII+, according to the manufacturer's instructions. Viscosity is measured using cup and bob geometry configuration in which Spindle #31 is rotated at 60 rpm to obtain an approximate shear rate of 20 s-1. The viscosity is then measured at 21° C.

### EXAMPLES

The examples provided below are intended to be illustrative in nature and are not intended to be limiting.

In the following examples, the nomenclature below is used to describe the tested PEI polymers.
PEI 1 Ethoxylated/propoxylated polyethyleneimine (PEI600 EO24 PO16, ex BASF)
PEI 2 Ethoxylated polyethyleneimine (PEI600 EO20, ex BASF)

### Example 1. Effects of Residual Contamination on a Manufacturing Line

To show the effects that residual contamination of certain PEI polymers may have on later-made products, a first detergent composition was made on a pilot-scale manufacturing line. The first detergent composition included PEI 1. The same manufacturing line was then used to make a second, different detergent composition that was intended to be free of PEI 1 (i.e., no PEI 1 was intentionally formulated into the composition).

Between the making of the first and the second detergent compositions, the manufacturing line was flushed with a fluid to remove residual amounts of the first detergent composition.

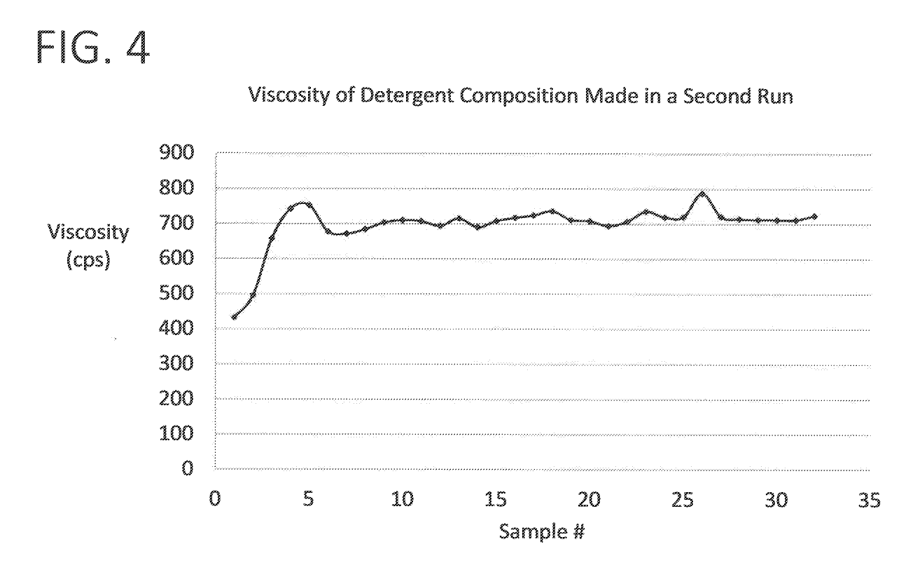

As the second detergent composition was being made, it was subdivided into approximately thirty samples taken sequentially off the manufacturing line (i.e., sample #1 was the first amount of composition made, sample #2 was the second amount, etc.). The viscosity of the samples were determined and are shown in the graph of FIG. 4.

As seen in the graph of FIG. 4, the samples made early in the run (e.g., samples #1-2) are characterized by relatively low viscosities compared to samples made later in the same run. Without wishing to be bound by theory, it is believed that residual contamination from the first detergent composition, specifically PEI 1, contributed to the lower viscosities of the initial samples of the second detergent composition.

Subsequent tests, the results of which are not shown here, have demonstrated that the viscosity differences between initial and later samples in a run may be lessened by additional flushing of the line (e.g., greater amounts of flush), but this may require additional time and/or create additional waste.

### Example 2. Effects of a Particular PEI Polymer on Viscosity

To show the effects of a particular PEI polymer (PEI 1) on viscosity, three liquid base compositions are prepared. The base compositions are suitable for subsequent modification, such as by the addition of detergent adjuncts, to form a final detergent product. Base A and Base C do not include a PEI polymer. Base B has substantially the same formulation as Base A, but includes PEI 1 (PEI600 EO24 P016), which is ethoxylated and propoxylated.

Additionally, a “finished” detergent product, Detergent D, is also prepared. Formulations for Bases A, B, and C, and Detergent D are provided in Table 1.

TABLE 1

| | Base A | Base B | Base C | Detergent D |
|---|---|---|---|---|
| Alkyl ethoxylated sulfate | 20.436 | 20.436 | 13.256 | 8.55 |
| (AES) | | | | |
| Linear alkyl benzene | 11.244 | 11.244 | 1.862 | 1.201 |
| sulphonate (HLAS) | | | | |
| DTPA (chelant) | 0.83 | 0.83 | 0.697 | 0.450 |
| Sodium tetraborate | 2.345 | 2.345 | 2.462 | 1.588 |
| NaOH | 1.205 | 1.205 | 0.167 | 0.108 |
| Monoethanolamine | 3.73 | 3.73 | 1.787 | 1.153 |
| PEI 1 | 0 | 2.41 | 0 | 0 |
| Citric acid | 3.876 | 3.876 | 2.574 | 1.661 |
| Calcium formate | 0.199 | 0.199 | 0.186 | 0.12 |
| Amine oxide | 0 | 0 | 0.814 | 0.525 |
| Sodium formate | 0 | 0 | 0.378 | 1.144 |
| Perfume | 0 | 0 | 0 | 0.55 |
| Water and minors | balance | balance | balance | balance |

Following preparation, the base compositions, respectively, are combined with Detergent D to simulate contamination at various levels (0%-10%). In Leg 1, Detergent D is “contaminated” with Base A. In Leg 2, Detergent D is “contaminated” with Base B, which included PEI 1. In Leg 3, Detergent D is “contaminated” with Base C. Viscosity of the resulting (contaminated) compositions is measured using the test method provided above. Results (in cps) are provided in Table 2.

TABLE 2

| | Viscosity (cps) | | |
|---|---|---|---|
| | Leg 1 | Leg 2 | Leg 3 |
| % base | Contaminant: | Contaminant: | Contaminant: |
| contamination | Base A | Base B | Base C |
| into Detergent D | (nil-PEI 1) | (incl. PEI 1) | (nil-PEI 1) |
| 0% | 506.7 | 506.7 | 506.7 |
| 0.25% | Not tested | 492 | 549.3 |
| 0.5% | 576 | 484.5 | 538.7 |
| 1% | Not tested | 458 | 528 |
| 2.5% | 650.7 | 397 | 560 |
| 5% | Not tested | 383 | 565.3 |
| 10% | 826.7 | 394.5 | 597.3 |

The results shown in Table 2 show the surprising degree to which a PEI polymer, such as PEI 1, can affect the viscosity of a composition as described in the present disclosure.

For example, as shown in Table 2, the viscosity of a detergent composition “contaminated” by Base B, which include PEI 1, decreases significantly, particularly when compared to contamination by Base A, which has a similar composition but does not include a PEI polymer; compare, for example, viscosities of Legs 1 and 2 at a 0.5% contamination level.

Table 2 also shows that as the level of contamination by a composition having PEI 1 goes up, the viscosity decreases; see Leg 2.

Furthermore, the results in Table 2 show that a detergent composition contaminated by a composition containing PEI 1 (i.e., Base B) shows a viscosity decrease compared to a detergent composition contaminated by a different, nil-PEI composition (Base C).

### Example 3. Effects of Different PEI Polymers on Viscosity

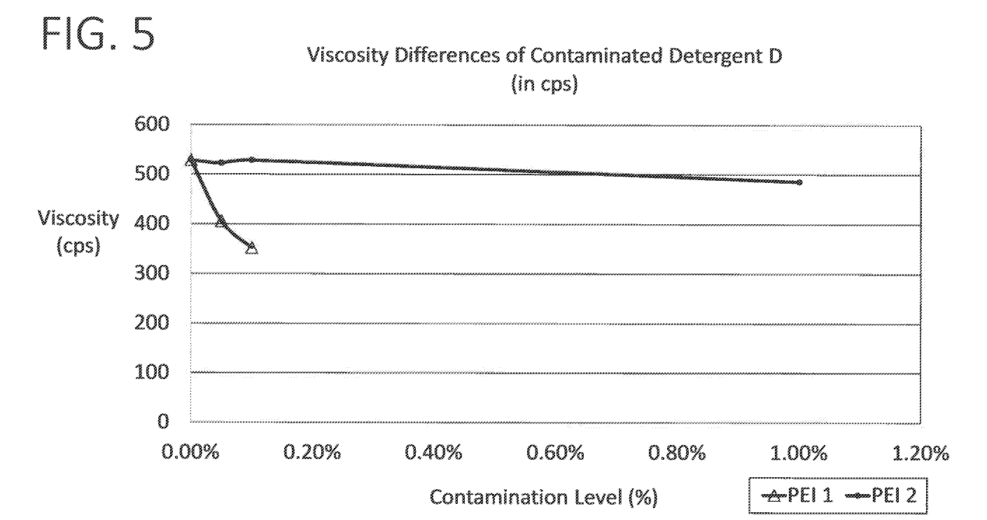

To show the effects of different PEI polymers on detergent viscosity, Detergent D (as described above and shown in Table 1) is combined directly with PEI 1 (PEI600 EO24 P016) and PEI 2 (PEI600 EO20), respectively, to simulate contamination at different polymer levels. Viscosity was measured according to the test method above. Results are in Table 3 below, and shown as a graph in FIG. 5.

TABLE 3

| | |
|---|---|
| % polymer | Viscosity (cps) |

| contamination | Contaminant: | Contaminant: |
|---|---|---|
| into Detergent D | PEI 1 | PEI 2 |
| 0% | 528 | 528 |
| 0.05% | 405.3 | 522.3 |
| 0.1% | 352 | 528 |
| 1% | Not tested | 485.3 |

The results in Table 3 show that PEI 1 polymer has a greater impact on viscosity than PEI 2 polymer when contaminated into the model detergent. For example, with a 0.1% level of contamination of PEI 1 polymer, the viscosity of the contaminated detergent drops by 33%, whereas no significant viscosity drop is seen at 0.1% contamination with PEI 2. Furthermore, a 0.05% contamination level of PEI 1 results in a greater viscosity decrease than even a 1% contamination level of PEI 2.

As shown by the results in Examples 1-3, contamination of a detergent composition with certain PEI polymers, either as part of a base composition or directly, can significantly decrease the viscosity of the resulting composition. Furthermore, as shown in Example 3, not all PEI polymers provide the same degree of viscosity decrease.

The contaminating presence of such PEI polymers can result in variable viscosity profiles for detergent products produced on the manufacturing equipment. For example, product made early in the manufacturing run may be contaminated by the polymer and may have relatively low viscosities compared to products made later in the run; see Example 1. To counter-balance this problem, it may be advantageous to add the certain PEI polymers relatively late in the manufacturing process so that less equipment (e.g., fewer linear feet of a pipe) carries the contaminating polymer so that the overall net level of residual polymer is relatively reduced, and/or less equipment must be flushed between runs, resulting in less waste.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of making a liquid detergent composition, the process comprising the steps of:
providing a manufacturing line comprising, in series and in fluid communication, an upstream region, a confluence region, and a downstream region;
providing a liquid base composition at the upstream region,
the liquid base composition comprising at least one surfactant and at least one detergent adjunct; and
combining the liquid base composition with an alkoxylated polyethyleneimine (PEI) polymer in the confluence region, thereby resulting in a detergent composition at the downstream region,
wherein the alkoxylated PEI polymer comprises, on an average molar basis, from about 5 to about 50 ethoxy (EO) groups per alkoxylated nitrogen, and from about 1 to about 20 propoxy (PO) groups per alkoxylated nitrogen.

2. A process according to claim 1, wherein the process further comprises adding one or more additional detergent adjuncts to the liquid base composition, the detergent composition, or both.

3. A process according to claim 1, wherein the at least one detergent adjunct comprises a builder, an organic polymeric compound, an enzyme, an enzyme stabilizer, a bleach system, a brightener, a hueing agent, a chelating agent, a suds suppressor, a conditioning agent, a humectant, neat perfume, encapsulated benefit agents, a filler or carrier, or mixtures thereof.

4. A process according to claim 1, wherein the liquid base composition comprises from about from about 1% to about 75%, by weight of the liquid base composition, of surfactant.

5. A process according to claim 1, wherein the surfactant comprises anionic surfactant selected from alkyl alkoxylated sulfate, alkyl sulfate, alkyl benzene sulphonate, or mixtures thereof.

6. A process according to claim 5, wherein the surfactant comprises alkyl ethoxylated sulfate and alkyl benzene sulphonate.

7. A process according to claim 1, wherein the alkoxylated PEI polymer is combined with the liquid base composition in an amount suitable to provide from about 0.01% to about 5%, by weight of the final detergent composition.

8. A process according to claim 1, wherein the alkoxylated PEI polymer comprises a PEI backbone characterized by a weight average molecular weight, prior to alkoxylation, of from about 200 to about 1500.

9. A process according to claim 1, wherein the alkoxylated PEI polymer comprises, on an average molar basis, from about 10 to about 50, or from about 15 to about 40, or from about 20 to about 30 ethoxy (EO) groups per alkoxylated nitrogen.

10. A process according to claim 1, wherein the alkoxylated PEI polymer comprises, on an average molar basis, from about 1 to about 50, or from about 5 to about 40, or from about 10 to about 30 propoxy (PO) groups per alkoxylated nitrogen.

11. A process according to claim 1, wherein the alkoxylated PEI polymer comprises alkoxylate units having an inner EO block and an outer PO block.

12. A process according to claim 11, wherein the inner EO block comprises from about 10 to about 50 EO groups, and wherein the outer PO block comprises from about 1 to about 50 PO groups.

13. A process according to claim 1, wherein the average molar ratio of EO groups to PO groups is from about 0.5 to about 5.

14. A process according to claim 1, wherein the detergent composition comprises the alkoxylated PEI polymer and at least a second alkoxylated PEI polymer.

15. A process according to claim 1, wherein the second alkoxylated PEI polymer is an ethoxylated PEI polymer.

16. A process according to claim 1, wherein the liquid base composition further comprises a PEI polymer, where the PEI polymer is the same as or is different from the alkoxylated PEI polymer of claim 1.

17. A process according to claim 1, wherein the process further comprises a filling step, wherein the detergent composition is placed into a container at a location further downstream of the downstream region, preferably wherein the filling step occurs less than about 10 minutes after the alkoxylated PEI polymer is added to the liquid base composition.

18. A process according to claim 1,
wherein a first amount of the liquid base composition is provided at the upstream region and the detergent composition is a first detergent composition, and
wherein the process further comprises the steps of
providing a second amount of the liquid base composition at the upstream region of the manufacturing line, and
combining the liquid base composition with at least one additional detergent adjunct, resulting in a second detergent composition at the downstream region, wherein none of the alkoxylated PEI polymer is affirmatively added to second detergent composition.

19. The process of claim 18, wherein at least a portion of the manufacturing line is flushed with a flowable/liquid composition between making the first detergent composition and the second detergent composition.

20. The process according to claim 18, wherein at least a portion of the flowable/liquid composition is captured after being flushed through the manufacturing line, and optionally is combined with the liquid base composition and/or the second detergent composition.
